(19) United States
(12) Patent Application Publication
(10) Pub. No.: US 2019/0293202 A1
(43) Pub. Date: Sep. 26, 2019

(54) ELECTROMAGNETIC VALVE AND FLOW PATH DEVICE

(71) Applicant: NIDEC TOSOK CORPORATION, Kanagawa (JP)

(72) Inventors: Daisuke MURATA, Kanagawa (JP); Keita KOBAYASHI, Kanagawa (JP); Tomohiro YASUDA, Kanagawa (JP); Kenro TAKAHASHI, Kanagawa (JP)

(73) Assignee: NIDEC TOSOK CORPORATION, Kanagawa (JP)

(21) Appl. No.: 16/360,039

(22) Filed: Mar. 21, 2019

(30) Foreign Application Priority Data
Mar. 26, 2018 (JP) 2018-058259

(51) Int. Cl. F16K 31/06; F16K 1/36; F16K 1/46

(52) U.S. Cl. CPC F16K 31/06; F16K 1/46; F16K 1/36

(57) ABSTRACT

An electromagnetic valve and a flow path device are provided, and the electromagnetic valve includes: a main body, a tube member and a connection flow path portion. A movable portion has a shaft portion, a valve body and a partitioning portion. The partitioning portion is located on the one side in the axial direction beyond the valve body and partitions the inner portion of the tube member into a first accommodation portion and a second accommodation portion. The second flow path portion is connected to the second accommodation portion in the opened state. The connection flow path portion is provided at the movable portion and connects the first flow path portion to the first accommodation portion in the closed state. The first accommodation portion is able to accommodate a fluid flowing through the first flow path portion and is disconnected from the second flow path portion in the closed state.

### CROSS-REFERENCE TO RELATED APPLICATION

This application claims the priority benefit of Japan Application No. 2018-058259, filed on Mar. 26, 2018. The entirety of the above-mentioned patent application is hereby incorporated by reference herein and made a part of specification.

### BACKGROUND

### Technical Field

The present disclosure relates to an electromagnetic valve and a flow path device.

### Description of Related Art

An electromagnetic valve that opens and closes a flow path is known. For example, Patent Document 1 describes a latch-type electromagnetic valve.

### PATENT DOCUMENTS

[Patent Document 1] Japanese Patent Laid-Open No. 2002-250457

When a flow path is closed with an electromagnetic valve as described above, a pressure of a fluid flowing through the flow path is applied to a valve body of the electromagnetic valve. Therefore, in a case in which the flow amount of the flow path is relatively large, relatively large force is needed to maintain the valve body in the closed state, and the size of the electromagnetic valve may increase.

### SUMMARY

The present disclosure provides an electromagnetic valve with a structure capable of allowing realizing size reduction and a flow path device provided with such the electromagnetic valve.

According to an embodiment of the disclosure, there is provided an electromagnetic valve that includes a movable portion that can move along a central axis extending in an axial direction and that is able to switch a state between an opened state in which a first flow path portion and a second flow path portion located on one side of the first flow path portion in the axial direction are coupled to each other via a first hole and a closed state in which the first hole is blocked and the first flow path portion and the second flow path portion are disconnected, the electromagnetic valve including: a main body that has a solenoid that causes the movable portion to move in the axial direction and a cover that accommodates the solenoid, a tube member with a tubular shape extending from the main body to the other side in the axial direction, and a connection flow path portion that connects an outer portion of the electromagnetic valve to an inner portion of the tube member. A movable portion has a shaft portion that projects from the main body to the other side in the axial direction and is inserted into the inner portion of the tube member, a valve body that is provided at the shaft portion and blocks a first hole from one side in the axial direction in a closed state, and a partitioning portion that widens outwardly in a radial direction from an outer peripheral surface of a portion of the shaft portion that is inserted into the inner portion of the tube member. The partitioning portion is located on the one side in the axial direction beyond the valve body and partitions the inner portion of the tube member into a first accommodation portion and a second accommodation portion that is located on the other side of the first accommodation portion in the axial direction. The second flow path portion is connected to the second accommodation portion in the opened state. The connection flow path portion is provided at the movable portion and connects the first flow path portion to the first accommodation portion in the closed state. The first accommodation portion is able to accommodate a fluid flowing through the first flow path portion and is disconnected from the second flow path portion in the closed state.

According to another embodiment of the disclosure, there is provided a flow path device including: the aforementioned electromagnetic valve; and a flow path portion that has the first flow path portion, the second flow path portion, and the first hole.

According to the embodiment, it is possible to reduce the size of the electromagnetic valve.

### BRIEF DESCRIPTION OF THE DRAWINGS

FIG. 1 is a sectional view schematically illustrating a flow path system provided with a flow path device according to a first embodiment.

FIG. 2 is a sectional view schematically illustrating the flow path system provided with the flow path device according to the first embodiment.

FIG. 3 is a sectional view illustrating an electromagnetic valve according to the first embodiment.

FIG. 4 is a sectional view illustrating the electromagnetic valve according to the first embodiment.

FIG. 5 is a sectional view illustrating a part of an electromagnetic valve according to a second embodiment.

FIG. 6 is a sectional view illustrating a part of the electromagnetic valve according to the second embodiment.

FIG. 7 is a perspective view illustrating a part of a movable portion according to the second embodiment.

FIG. 8 is a sectional view illustrating a part of an electromagnetic valve according to a modification example of the second embodiment.

FIG. 9 is a sectional view illustrating a part of the electromagnetic valve according to the modification example of the second embodiment, which is a sectional view taken along IX-IX in FIG. 10.

FIG. 10 is a perspective view illustrating a part of a movable part according to the modification example of the second embodiment.

### DESCRIPTION OF THE EMBODIMENTS

In each drawing, a Z-axis direction represents an upward-downward direction with a positive side on the upper side and a negative side on the lower side. An axial direction of a central axis J, which is a virtual axis appropriately illustrated in each drawing, is parallel to the Z-axis direction, that is, the upward-downward direction. In the following description, a direction parallel to the axial direction of the central axis J will simply be referred to as an “axial direction”, a radial direction around the central axis J will simply be referred to as a “radial direction”, and a circumferential direction around the central axis J will simply be referred to as a “circumferential direction”.

In the embodiment, the upper side corresponds to one side in the axial direction, and the lower side corresponds to the other side in the axial direction. Note that the upward-downward direction, the upper side and the lower side are merely names for describing relative positional relationships of respective parts, and actual disposition relationships and the like may be disposition relationships other than the disposition relationships and the like represented using these names.

### First Embodiment

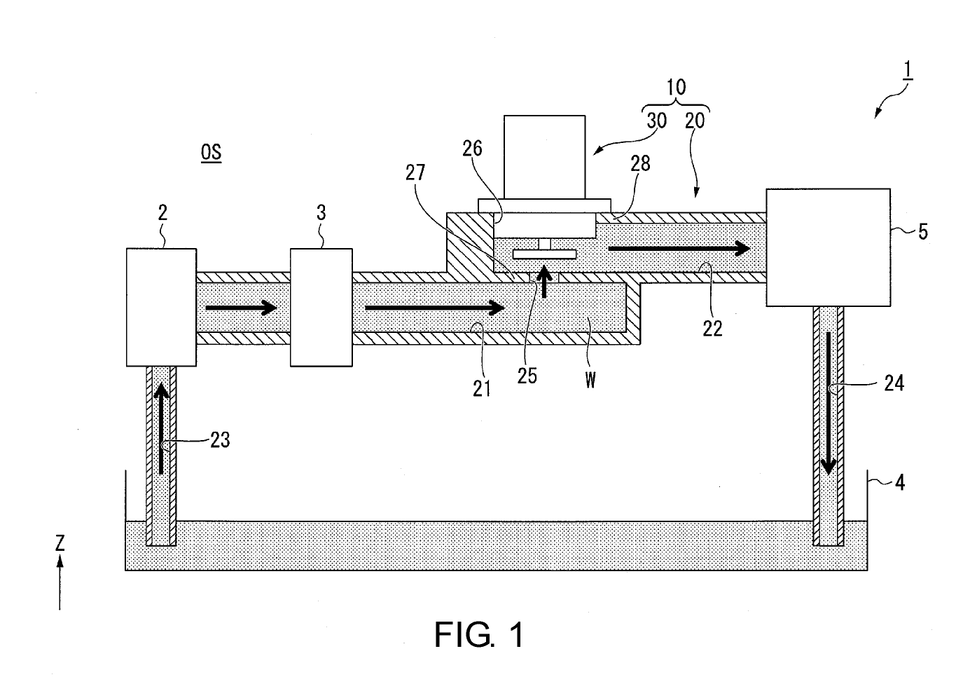

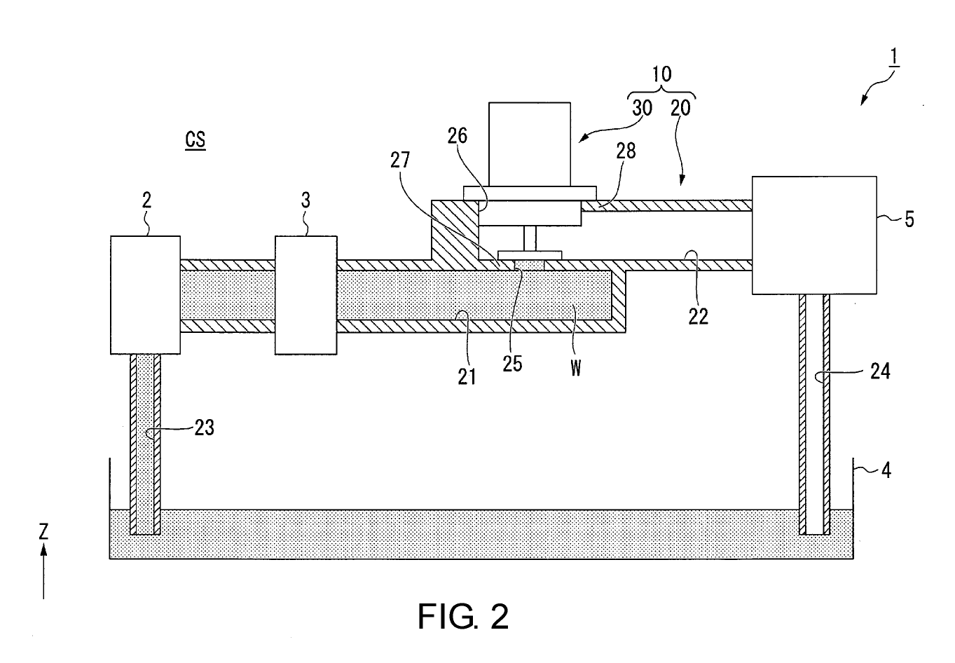

As illustrated in FIGS. 1 and 2, a flow path device 10 according to an embodiment includes a flow path portion 20 through which a fluid W flows and an electromagnetic valve 30 that opens and closes the flow path portion 20. The fluid W is not particularly limited and is water, for example. FIG. 1 illustrates an opened state OS in which the electromagnetic valve 30 is opened and the fluid W flows into the flow path portion 20. FIG. 2 illustrates a closed state CS in which the electromagnetic valve 30 is closed and a flow of the fluid W into the flow path portion 20 is blocked. The electromagnetic valve 30 can be switched between the opened state

OS and the closed state CS.

The flow path device 10 according to the embodiment is included in a flow path system 1. The flow path system 1 is a cooling system that cools a target to be cooled 5. The flow path system 1 is mounted in a vehicle, for example. The target to be cooled 5 is a drive unit of the vehicle, for example.

The flow path system 1 includes a pump portion 2, a fluid cooling portion 3, a fluid tank 4, a target to be cooled 5, and the flow path device 10. The pump portion 2 feeds the fluid W in the fluid tank 4 to the target to be cooled 5. The fluid cooling portion 3 cools the fluid W in the flow path portion 20. The fluid cooling portion is provided at a portion between the pump portion 2 and the target to be cooled 5 in the flow path portion 20.

The flow path portion 20 has a first flow path portion 21, a second flow path portion 22, a flow-in portion 23, and a flow-out portion 24. The flow-in portion 23 is a flow path extending from the fluid tank 4 to the pump portion 2. The flow-out portion 24 is a flow path extending from the target to be cooled 5 to the fluid tank 4. The first flow path portion 21 is a flow path extending from the pump portion 2. The fluid W fed by the pump portion 2 flows into the first flow path portion 21. In the embodiment, the fluid cooling portion 3 is provided in the first flow path portion 21.

The second flow path portion 22 is a flow path extending from the first flow path portion 21 to the target to be cooled 5. The second flow path portion 22 is located on the upper side of the first flow path portion 21. The first flow path portion 21 and the second flow path portion 22 are partitioned with a partitioning wall 27 in the axial direction. The partitioning wall 27 is a wall extending in a direction that perpendicularly intersects the axial direction and forms a part of a wall on the upper side of the first flow path portion 21 and a part of a wall on the lower side of the second flow path portion 22. The partitioning wall 27 has a first hole 25 that penetrates through the partitioning wall 27 in the axial direction. That is, the flow path portion 20 has a first hole 25. Although not illustrated in the drawing, the first hole 25 is a circular hole, for example. In the opened state OS illustrated in FIG. 1, the first flow path portion 21 and the second flow path portion 22 are connected to each other via the first hole 25.

The second flow path portion 22 has an attachment hole 26 to which the electromagnetic valve 30 is attached. The attachment hole 26 is provided in an upper wall 28 on the upper side in the wall of the second flow path portion 22. The attachment hole 26 penetrates through the upper wall 28 in the axial direction. The attachment hole 26 is located on the upper side of the first hole 25. Although not illustrated in the drawing, the attachment hole 26 is a circular hole, for example. The inner diameter of the attachment hole 26 is greater than the inner diameter of the first hole 25.

Note that “the second flow path portion located on the upper side of the first flow path portion” in this specification means that a portion of the second flow path portion that is connected to the first flow path portion via the hole is located on the upper side of a portion of the first flow path portion that is connected to the second flow path portion via the hole. That is, “the second flow path portion located on the upper side of the first flow path portion” in this specification also includes a case in which a part of the second flow path portion is located on the lower side of the first flow path portion.

As illustrated in FIG. 1, in the opened state OS, the fluid W in the fluid tank 4 flows into the first flow path portion 21 via the flow-in portion 23 by the pump portion 2. The fluid W that has flowed into the first flow path portion 21 flows into the second flow path portion 22 via the first hole 25. The fluid W that has flowed into the second flow path portion 22 cools the target to be cooled 5 and is returned to the fluid tank 4 via the flow-out portion 24. In this manner, the fluid W is circulated between the fluid tank 4 and the flow path portion 20 and can cool the target to be cooled 5 with the fluid W in the opened state OS.

Meanwhile, the first hole 25 is blocked with the electromagnetic valve 30, and the first flow path portion 21 and the second flow path portion 22 are disconnected in the closed state CS as illustrated in FIG. 2. In this manner, the fluid W does not flow through the second flow path portion 22, and the cooling of the target to be cooled 5 is stopped.

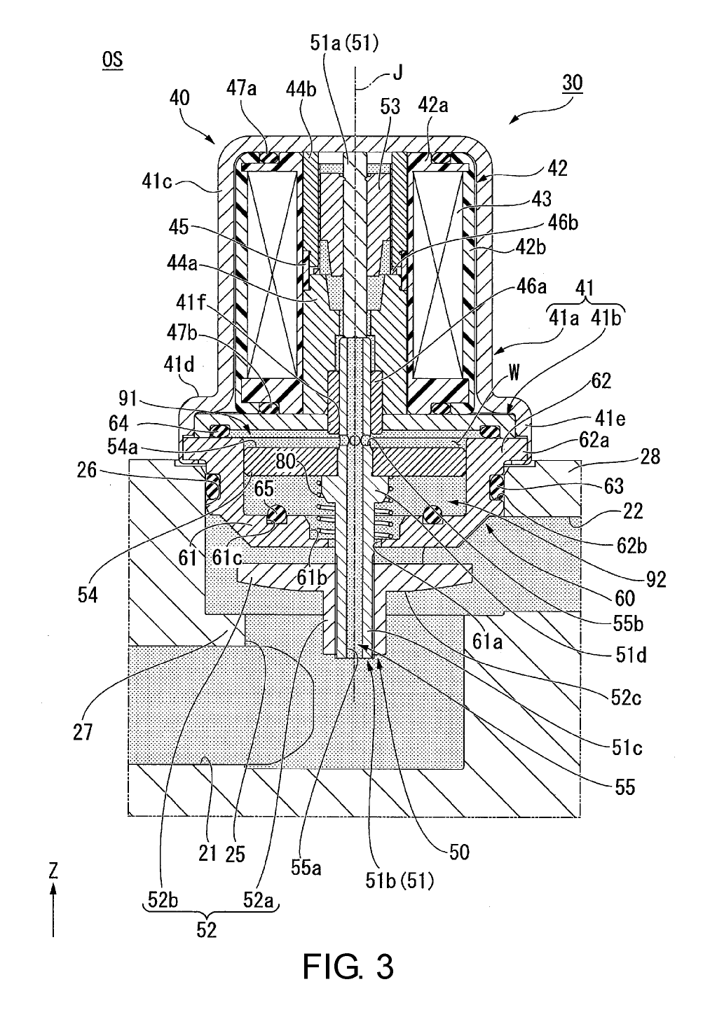

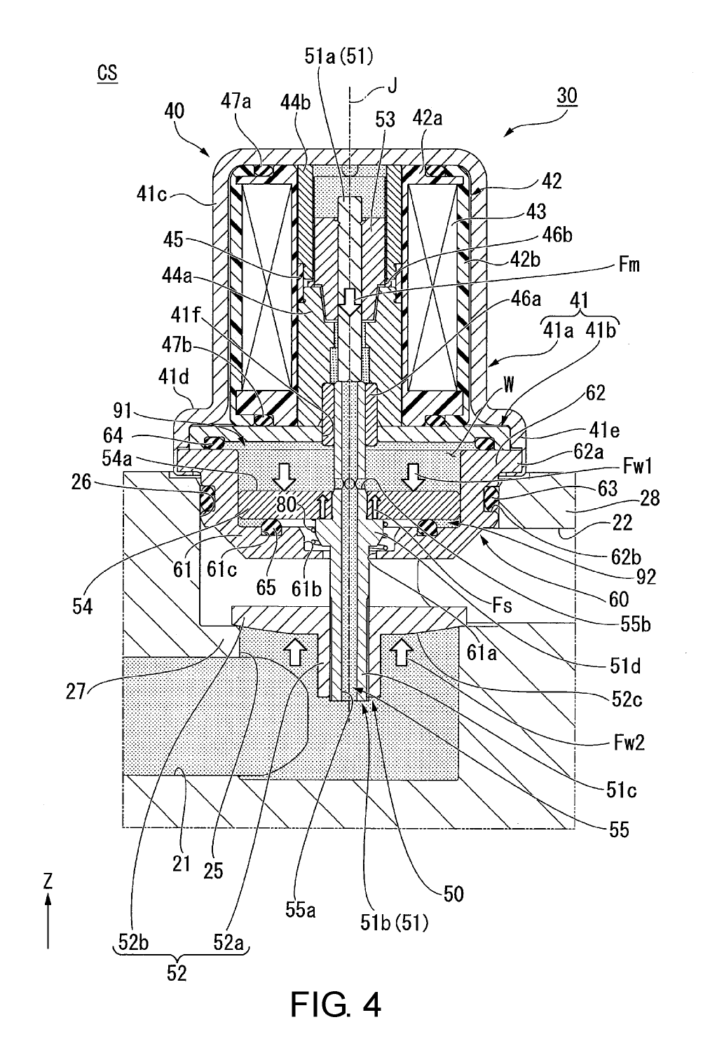

The electromagnetic valve 30 is secured to the flow path portion 20. More specifically, the electromagnetic valve 30 is attached to the attachment hole 26 and is secured to the upper wall 28 of the second flow path portion 22. As illustrated in FIGS. 3 and 4, the electromagnetic valve 30 includes a main body 40, a movable portion 50, a tube member 60, an elastic member 80, and a sealing member 65. Note that FIG. 3 illustrates the opened state OS and FIG. 4 illustrates the closed state CS.

The main body 40 has a cover 41, a solenoid 42, a first magnetic member 44a, a second magnetic member 44b, a spacer 45, bushes 46a and 46b, and O rings 47a and 47b. The cover 41 accommodates the solenoid 42. The cover 41 is a magnetic member. The cover 41 is secured to the upper wall 28. The cover 41 has a first cover 41a and a second cover 41b.

The first cover 41a has a cover main body 41c, an annular plate portion 41d, and a holding portion 41e. The cover main body 41c has a tubular shape with a cover that is opened on the lower side. The cover main body 41c has a cylindrical shape around the central axis J in the embodiment. The annular plate portion 41d widens outwardly in the radial direction from a lower end of the cover main body 41c. The holding portion 41e has a tubular shape that projects downwardly from an outer edge of the annular plate portion 41d in the radial direction.

The second cover 41b has a plate shape with a plate surface directed in the axial direction. Although not illustrated in the drawing, the second cover 41b has a disk shape around the central axis J in the embodiment. The second cover 41b is fitted to the inner side of the holding portion 41e in the radial direction. The second cover 41b closes the lower opening of the first cover 41a. The second cover 41b has a cover through-hole 41f that penetrates through the center of the second cover 41b in the axial direction.

The solenoid 42 has a bobbin portion 42a, a coil 43, and a mold portion 42b. The bobbin portion 42a has a tubular shape that extends in the axial direction and is opened on opposite sides in the axial direction. The bobbin portion 42a has a cylindrical shape around the central axis J in the embodiment. The lower end of the bobbin portion 42a is in contact with the second cover 41b. The upper end of the bobbin portion 42a is in contact with the upper lid of the first cover 41a. The coil 43 is wound around the outer peripheral surface of the bobbin portion 42a. The mold portion 42b covers the outer side of the bobbin portion 42a in the radial direction and the outer side of the coil 43 in the radial direction.

The first magnetic member 44a and the second magnetic member 44b have tubular shapes that extend in the axial direction and are opened on opposite sides in the axial direction. In the embodiment, the first magnetic member 44a and the second magnetic member 44b have tubular shapes around the central axis J. The first magnetic member 44a and the second magnetic member 44b are fitted to the inner side of the bobbin portion 42a in the radial direction. The lower end of the first magnetic member 44a is in contact with the second cover 41b. The second magnetic member 44b is located on the upper side of the first magnetic member 44a. The upper end of the second magnetic member 44b is in contact with an upper lid of the first cover 41a. The first magnetic member 44a and the second magnetic member 44b are magnetic materials.

The spacer 45 has a tubular shape that extends in the axial direction and is opened on opposite sides in the axial direction. The spacer 45 has a cylindrical shape around the central axis J in the embodiment. The spacer 45 is located at a portion between the first magnetic member 44a and the second magnetic member 44b in the axial direction. Both ends of the spacer 45 in the axial direction are in contact with respective magnetic members. The spacer 45 is of a non-magnetic material. The spacer 45 is made of resin, for example.

The bushes 46a and 46b have tubular shapes that extend in the axial direction and are opened on opposite sides in the axial direction. The bushes 46a and 46b have cylindrical shapes around the central axis J in the embodiment. The lower end of the bush 46a is fitted to the cover through-hole 41f. The upper portion of the bush 46a is fitted to the inner side of the first magnetic member 44a in the radial direction. The bush 46b is fitted to the inner side of the second magnetic member 44b in the radial direction.

The O rings 47a and 47b have annular shapes in the circumferential direction. The O rings 47a and 47b have cylindrical shapes around the central axis J in the embodiment. The O ring 47a is located at a portion between the upper end of the bobbin portion 42a and the upper lid of the first cover 41a. The O ring 47a is brought into contact with the bobbin portion 42a and the first cover 41a and seals a portion between the bobbin portion 42a and the first cover 41a. The O ring 47b is located at a portion between the lower end of the bobbin portion 42a and the second cover 41b. The O ring 47b is brought into contact with the bobbin portion 42a and the second cover 41b and seals a portion between the bobbin portion 42a and the second cover 41b.

The movable portion 50 can move along the central axis J extending in the axial direction. The movable portion 50 has a shaft portion 51, a valve portion 52, a core portion 53, and a partitioning portion 54. The shaft portion 51 extends along the central axis J. The shaft portion 51 projects downwardly from the main body 40 and is inserted into the inner portion of the tube member 60. In addition, the shaft portion 51 is inserted into the inner portion of the second flow path portion 22 via the attachment hole 26. In the embodiment, the shaft portion 51 has a first shaft portion 51a and a second shaft portion 51b. The first shaft portion 51a and the second shaft portion 51b are mutually separate members.

The first shaft portion 51a has a columnar shape extending in the axial direction. The first shaft portion 51a has a circular columnar shape around the central axis J in the embodiment. The first shaft portion 51a is located inside the main body 40. The first shaft portion 51a is disposed across the inner portion of the first magnetic member 44a, the inner portion of the spacer 45, and the inner portion of the second magnetic member 44b.

The second shaft portion 51b has a second shaft portion main body 51c and a projecting portion 51d. The second shaft portion main body 51c has a tubular shape extending in the axial direction. The second shaft portion main body 51c has a cylindrical shape around the central axis J that is opened on opposite sides in the axial direction in the embodiment. The outer diameter of the second shaft portion main body 51c is greater than the outer diameter of the first shaft portion 51a. The inner diameter of the second shaft portion main body 51c is smaller than the outer diameter of the first shaft portion 51a.

The second shaft portion main body 51c is located on the lower side of the first shaft portion 51a. An upper end of the second shaft portion main body 51c is located inside the main body 40. The upper end of the second shaft portion main body 51c is fitted into the inner side of the bush 46a in the radial direction and is supported by the bush 46a such that the upper end of the second shaft portion main body 51c can move in the axial direction. The upper end of the second shaft portion main body 51c can be brought into contact with the lower end of the first shaft portion 51a. In the embodiment, the upper end of the second shaft portion main body 51c is brought into contact with the lower end of the first shaft portion 51a at least in the opened state OS and the closed state CS.

The lower portion of the second shaft portion main body 51c projects downwardly from the inner portion of the main body 40 and is inserted into the inner side of the second flow path portion 22 via the attachment hole 26. The center of the second shaft portion main body 51c in the axial direction is inserted into the inner portion of the tube member 60. The lower end of the second shaft portion main body 51c projects downwardly beyond the tube member 60. In the embodiment, the lower end of the second shaft portion main body 51c penetrates through the inner portion of the second flow path portion 22 in the axial direction and projects to the inner portion of the first flow path portion 21 via the first hole 25 in both the opened state OS and the closed state CS. A male screw portion is provided in an outer peripheral surface of the second shaft portion main body 51c at the lower end.

The projecting portion 51d projects outwardly in the radial direction from the center of the second shaft portion main body 51c in the axial direction. The projecting portion 51d has an annular shape around the central axis J in the embodiment. The projecting portion 51d is located in the inner portion of the tube member 60.

The valve portion 52 has a secured tube portion 52a and a valve body 52b. That is, the movable portion 50 has the secured tube portion 52a and the valve body 52b. The secured tube portion 52a has a tubular shape extending in the axial direction. The secured tube portion 52a has a cylindrical shape around the central axis J that is closed on opposite sides in the axial direction in the embodiment. A female screw portion is provided in an inner peripheral surface of the secured tube portion 52a. The secured tube portion 52a is secured to the lower portion of the second shaft portion main body 51c by the female screw portion in the inner peripheral surface being fastened to the male screw portion of the second shaft portion main body 51c. The lower end of the secured tube portion 52a is located on the upper side beyond the lower end of the second shaft portion main body 51c.

The valve body 52b is secured to the lower portion of the second shaft portion main body 51c via the secured tube portion 52a. In this manner, the valve body 52b is provided at the shaft portion 51. The valve body 52b widens outwardly in the radial direction from the upper end of the secured tube portion 52a. In the embodiment, the valve body 52b has an annular plate shape around the central axis J with a plate surface directed in the axial direction. The outer diameter of the valve body 52b is greater than the outer diameter of the projecting portion 51d and the inner diameter of the first hole 25. The lower surface of the valve body 52b is a curved surface located on the upper side toward the outer sides in the radial direction in the embodiment. The upper surface of the valve body 52b is a flat surface that perpendicularly intersects the axial direction.

The valve body 52b is located in the inner portion of the second flow path portion 22. As illustrated in FIG. 4, the valve body 52b blocks the first hole 25 from the upper side in the closed state CS. In the closed state CS, the outer edge of the valve body 52b in the radial direction is brought into contact with an edge of the first hole 25 in the inner surface of the second flow path portion 22. The valve body 52b has a second pressure receiving surface 52c. The second pressure receiving surface 52c is a surface directed to the lower side and is a part of the lower surface of the valve body 52b. In the embodiment, the second pressure receiving surface 52c is a part of the lower surface of the valve body 52b except for an outer edge in the radial direction. The second pressure receiving surface 52c is exposed to the first flow path portion 21 in the closed state CS. The second pressure receiving surface 52c receives a pressure directed to the upper side from the fluid W in the first flow path portion 21 in the closed state CS.

The core portion 53 extends in the axial direction. The core portion 53 has a cylindrical shape around the central axis J in the embodiment. The core portion 53 is fitted and secured to the outer peripheral surface of the first shaft portion 51a. The core portion 53 is fitted into the inner side of the bush 46b in the radial direction and is supported by the bush 46b such that the core portion 53 can move in the axial direction. The core portion 53 is a magnetic member.

The partitioning portion 54 widens outwardly in the radial direction from an outer peripheral surface of a portion of the shaft portion 51 that is inserted into the inner portion of the tube member 60. The partitioning portion 54 widens outwardly in the radial direction from the outer peripheral surface of the second shaft portion main body 51c in the embodiment. The partitioning portion 54 has a plate shape with a plate surface directed in the axial direction. The partitioning portion 54 has a disk shape around the central axis J in the embodiment. A surface of the partitioning portion 54 in the axial direction is a flat surface that perpendicularly intersects the axial direction. The outer diameter of the partitioning portion 54 is greater than the outer diameter of the projecting portion 51d. The outer diameter of the partitioning portion 54 is substantially the same as the outer diameter of the valve body 52b. The outer diameter of the partitioning portion 54 is slightly smaller than the outer diameter of the valve body 52b in the embodiment.

The partitioning portion 54 is located on the lower side beyond the main body 40 and on the upper side beyond the valve body 52b. In the embodiment, the partitioning portion 54 is located in the inner portion of the attachment hole 26. The partitioning portion 54 is located on the upper side of the projecting portion 51d. An inner edge of the lower surface of the partitioning portion 54 in the radial direction is brought into contact with the upper surface of the projecting portion 51d. The partitioning portion 54 is fitted into the inner portion of the tube member main body 62, which will be described later. The outer peripheral surface of the partitioning portion 54 is brought into contact with the inner peripheral surface of the tube member main body 62. When the movable portion 50 moves in the axial direction, the partitioning portion 54 moves in the axial direction while the outer peripheral surface slides relative to the inner peripheral surface of the tube member main body 62. In the embodiment, the partitioning portion 54 is a member separate from the shaft portion 51.

The tube member 60 has a tubular shape extending downwardly from the main body 40. The tube member 60 is secured to the lower side of the main body 40. The tube member 60 is fitted into the attachment hole 26 and is secured to the upper wall 28. The tube member 60 has the tube member main body 62 and a bottom portion 61. The tube member main body 62 has a tubular shape extending downwardly from the main body 40. The tube member main body 62 has a cylindrical shape around the central axis J in the embodiment. The tube member main body 62 is fitted into the attachment hole 26. An upper end of the tube member main body 62 is brought into contact with and secured to an outer edge of the lower surface of the second cover 41b in the radial direction. In this manner, the upper end of the tube member main body 62 is secured to the main body 40.

An O ring 64 is provided between the upper end of the tube member main body 62 and the lower surface of the second cover 41b. The O ring 64 has an annular shape in the circumferential direction. A portion between the upper end of the tube member main body 62 and the lower surface of the second cover 41b is sealed with the O ring 64. The upper end of the tube member main body 62 has a projecting portion 62a that projects outwardly in the radial direction. The projecting portion 62a has an annular shape in the circumferential direction.

The projecting portion 62a is located on the upper side of the peripheral edge of the attachment hole 26 in the upper surface of the upper wall 28.

The tube member main body 62 has a groove 62b that is recessed inwardly in the radial direction from the outer peripheral surface of the tube member main body 62. The groove 62b has an annular shape in the circumferential direction. The groove 62b is provided at a portion of the outer peripheral surface of the tube member main body 62 that is fitted into the attachment hole 26. An O ring 63 is fitted into the groove 62b. The O ring 63 is brought into contact with a groove bottom surface of the groove 62b and the inner peripheral surface of the attachment hole 26. The O ring 63 seals a portion between the outer peripheral surface of the tube member main body 62 and the inner peripheral surface of the attachment hole 26. In this manner, it is possible to prevent leakage of the fluid W in the second flow path portion 22 from the attachment hole 26 to the outside.

The bottom portion 61 is connected to the lower end of the tube member main body 62. The bottom portion 61 widens in the radial direction in the inner portion of the second flow path portion 22. The outer diameter of the bottom portion 61 is greater than the outer diameter of the partitioning portion 54 and the outer diameter of the valve body 52b. The bottom portion 61 is located between the valve body 52b and the partitioning portion 54 in the axial direction.

The bottom portion 61 has a recessed portion 61b, a first through-hole 61a, and a groove 61c. The recessed portion 61b is recessed downwardly from the center of the upper surface of the bottom portion 61. The first through-hole 61a penetrates through the center of the bottom portion 61 in the axial direction. More specifically, the first through-hole 61a penetrates from the bottom surface of the recessed portion 61b to the lower surface of the bottom portion 61 in the axial direction. The shaft portion 51 is made to pass through the first through-hole 61a. The second shaft portion main body 51c is made to pass through the first through-hole 61a in the embodiment. The inner diameter of the first through-hole 61a is smaller than the outer diameter of the projecting portion 51d.

The groove 61c is recessed downwardly from the upper surface of the bottom portion 61. The groove 61c has an annular shape in the circumferential direction. The groove 61c is located on the outer side in the radial direction beyond the first through-hole 61a and the recessed portion 61b. A sealing member 65 is disposed in the groove 61c. In this manner, the sealing member 65 is disposed in the upper surface of the bottom portion 61 on the outer side beyond the first through-hole 61a in the radial direction. In the embodiment, the sealing member 65 has an annular shape surrounding the shaft portion 51 and is fitted into the groove 61c. The sealing member 65 has an annular shape around the central axis J. The sealing member 65 is an O ring, for example. The sealing member 65 projects on the upper side beyond the groove 61c. As illustrated in FIG. 4, the sealing member 65 is brought into contact with the lower surface of the partitioning portion 54 in the closed state CS and seals a portion between the upper surface of the bottom portion 61 and the lower surface of the partitioning portion 54. In the closed state CS, the sealing member 65 is in a compressed and elastically deformed state in the axial direction.

The elastic member 80 is supported from the lower side by the bottom portion 61. The elastic member 80 is located at a portion between the bottom portion 61 and the partitioning portion 54 in the axial direction. In the embodiment, the elastic member 80 is a coil spring extending in the axial direction. The upper end of the elastic member 80 is fitted to the projecting portion 51d from the outer side in the radial direction and is brought into contact with the lower surface of the partitioning portion 54. The lower portion of the elastic member 80 is inserted into the inner portion of the recessed portion 61b. The lower end of the elastic member 80 is brought into contact with the bottom surface of the recessed portion 61b. That is, the lower end of the elastic member 80 is brought into contact with the bottom portion 61. The elastic member 80 applies an elastic force Fs directed to the upper side to the movable portion 50 via the partitioning portion 54.

If a current is supplied to the coil 43 of the solenoid 42 in the opened state OS illustrated in FIG. 3, a magnetic field directed from the upper side to the lower side is generated on the inner side of the coil 43 in the radial direction. In this manner, a magnetic flux passes through the second magnetic member 44b, the core portion 53, the first magnetic member 44a, the second cover 41b, and the cover main body 41c in this order, and a magnetic circuit returning from the lid on the upper side of the cover main body 41c to the second magnetic member 44b is generated. With this magnetic circuit, the core portion 53 receives the electromagnetic force Fm directed to the lower side. Therefore, the core portion 53 and the first shaft portion 51a move downward, the first shaft portion 51a is pressed from the upper side, and the second shaft portion 51b also moves to the lower side. In this manner, the solenoid 42 can cause the movable portion 50 to move in the axial direction. As illustrated in FIG. 4, when the movable portion 50 moves to the lower side, the valve body 52b closes the first hole 25 and the opened state OS is switched to the closed state CS.

Meanwhile, if the current supply to the coil 43 of the solenoid 42 is stopped in the closed state CS, the aforementioned magnetic circuit disappears, and the electromagnetic force Fm generated in the core portion 53 also disappears. In this manner, the second shaft portion 51b and the valve body 52b move upward due to a fluid force Fw2 directed to the upper side that the valve body 52b receives from the fluid W in the first flow path portion 21 and the elastic force Fs directed to the upper side that the partitioning portion 54 receives from the elastic member 80, and the first hole 25 is opened. Therefore, the state is switched from the closed state CS to the opened state OS. Note that at this time, the first shaft portion 51a and the core portion 53 are also pressed by the second shaft portion 51b and move to the upper side.

As described above, the electromagnetic valve 30 can open and close the first hole 25 and switch the state between the opened state OS and the closed state CS by switching the supply and the stop of the current to the coil 43 of the solenoid 42.

The electromagnetic valve 30 further includes a first accommodation portion 91 and a second accommodation portion 92. The first accommodation portion 91 is a portion on the upper side of the inner portion of the tube member 60 that is partitioned with the partitioning portion 54. The second accommodation portion 92 is a portion on the lower side of the inner portion of the tube member 60 that is partitioned with the partitioning portion 54. That is, the partitioning portion 54 partitions the inner portion of the tube member 60 into the first accommodation portion 91 and the second accommodation portion 92 that is located on the lower side of the first accommodation portion 91.

The first accommodation portion 91 can accommodate the fluid W flowing through the first flow path portion 21. The first accommodation portion 91 is located on the upper side beyond the valve body 52b. The upper end of the inner portion of the first accommodation portion 91 is located on the upper side beyond the attachment hole 26. As illustrated in FIG. 4, the first accommodation portion 91 is disconnected from the second flow path portion 22 in the closed state CS.

In the embodiment, the first accommodation portion 91 is surrounded by the main body 40, the partitioning portion 54, and the tube member main body 62. The upper surface of the partitioning portion 54 is a first pressure receiving surface 54a that is directed to the upper side and forms a part of the inner surface of the first accommodation portion 91. That is, the movable portion 50 has the first pressure receiving surface 54a. In the embodiment, the first pressure receiving surface 54a is a flat surface that perpendicularly intersects the axial direction.

The area of the first pressure receiving surface 54a is the same as the area of the second pressure receiving surface 52c.

Note that in the specification, “the area of the first pressure receiving surface being the same as the area of the second pressure receiving surface” includes a case in which the area of the first pressure receiving surface is substantially the same as the area of the second pressure receiving surface in addition to the case in which the area of the first pressure receiving surface is the same as the area of the second pressure receiving surface in a strict sense.

As illustrated in FIG. 3, the second flow path portion 22 is connected to the second accommodation portion 92 via the first through-hole 61a in the opened state OS. In this manner, the second accommodation portion 92 can accommodate the fluid W flowing through the second flow path portion 22.

As illustrated in FIGS. 3 and 4, the volume of the first accommodation portion 91 and the volume of the second accommodation portion 92 vary between the opened state OS and the closed state CS. The volume of the first accommodation portion 91 in the closed state CS is greater than the volume of the first accommodation portion 91 in the opened state OS. The volume of the second accommodation portion 92 in the closed state CS is smaller than the volume of the second accommodation portion 92 in the opened state OS. The second accommodation portion 92 is brought into a state in which the fluid W is accommodated therein in the opened state OS, and is brought into a state in which the fluid W has substantially been discharged in the closed state CS.

The electromagnetic valve 30 further includes a connection flow path portion 55 that connects the outer portion of the electromagnetic valve 30 to the inner portion of the tube member 60. The connection flow path portion 55 is provided at the movable portion 50 and connects the first flow path portion 21 to the first accommodation portion 91 in the closed state CS. Therefore, a state in which the fluid W has flowed into the first accommodation portion 91 from the first flow path portion 21 via the connection flow path portion 55 is achieved in the closed state CS illustrated in FIG. 4. In this manner, the fluid force Fw1 directed to the lower side is applied to the first pressure receiving surface 54a of the partitioning portion 54 with the pressure of the fluid W in the first accommodation portion 91. Therefore, it is possible to offset at least a part of the fluid force Fw2 applied to the second pressure receiving surface 52c of the valve body 52b due to the pressure of the fluid W in the first flow path portion 21 by the fluid force Fw1. Therefore, it is possible to reduce the output of the electromagnetic valve 30 necessary to block the first hole 25 with the valve body 52b and to maintain the closed state CS. In this manner, it is possible to reduce the size of the electromagnetic valve 30.

Note that the output of the electromagnetic valve 30 in the embodiment is the electromagnetic force Fm. The closed state CS in the embodiment is maintained by the sum of the electromagnetic force Fm and the fluid force Fw1 being greater than the sum of the fluid force Fw2 and the elastic force Fs from the elastic member 80.

In addition, it is possible to further reduce a loss of the fluid W flowing from the first flow path portion 21 to the second flow path portion 22 in the opened state OS as the opening area of the first hole 25 increases, for example. However, meanwhile, the fluid force Fw2 applied to the second pressure receiving surface 52c of the valve body 52b further increases as the opening are of the first hole 25 increases. Therefore, it is necessary to increase the output of the electromagnetic valve, and the size of the electromagnetic valve may increase in some cases in the related art if it is attempted to increase the opening area of the first hole 25 to suppress the loss of the fluid W.

Meanwhile, according to the embodiment, it is possible to reduce the output of the electromagnetic valve 30 necessary to maintain the closed state CS as described above. Therefore, it is possible to maintain the closed state CS against the fluid force Fw2 that is larger than that in the related art without changing the output of the electromagnetic valve 30. In this manner, it is possible to increase the opening area of the first hole 25 and to reduce the loss of the fluid W flowing through the flow path portion 20 without increasing the size of the electromagnetic valve 30 as compared with the related art.

Also, according to the embodiment, the area of the first pressure receiving surface 54a is the same as the area of the second pressure receiving surface 52c. In addition, since the first accommodation portion 91 and the first flow path portion 21 are connected to each other, the pressure of the fluid W in the first accommodation portion 91 is substantially the same as the pressure of the fluid W in the first flow path portion 21. In this manner, it is possible to set the magnitude of the fluid force Fw1 applied to the first pressure receiving surface 54a and the magnitude of the fluid force Fw2 applied to the second pressure receiving surface 52c to be substantially the same. Therefore, it is possible to substantially offset the fluid force Fw2 that is applied to the second pressure receiving surface 52c and is directed to the upper side by the fluid force Fw1. Therefore, it is possible to reduce the output of the electromagnetic valve 30 necessary to maintain the closed state CS. In this manner, it is possible to reduce the size of the electromagnetic valve 30.

Also, according to the embodiment, the first pressure receiving surface 54a is a flat surface. Therefore, the fluid force Fw1 directed to the lower side tends to be stably received from the fluid W in the first accommodation portion 91. Therefore, it is possible to easily reduce the output of the electromagnetic valve 30 necessary to maintain the closed state CS and to further reduce the size of the electromagnetic valve 30.

In addition, an annular sealing member 65 that seals the portion between the upper surface of the bottom portion 61 and the lower surface of the partitioning portion 54 in the closed state CS is provided in the embodiment. Therefore, it is possible to prevent the fluid W leaking into the second accommodation portion 92 from leaking to the second flow path portion 22 with the sealing member 65 even in a case in which the fluid W in the first accommodation portion 91 leaks to the second accommodation portion 92 via the portion between the outer peripheral surface of the partitioning portion 54 and the inner peripheral surface of the tube member main body 62. In this manner, it is possible to suitably disconnect the first accommodation portion 91 from the second flow path portion 22 in the closed state CS and to suitably maintain the state in which the fluid W is accommodated in the first accommodation portion 91. Therefore, it is possible to more stably maintain the closed state CS.

The connection flow path portion 55 has a first portion 55a and second portions 55b. The first portion 55a is provided at the inner portion of the shaft portion 51 and extends in the axial direction. The first portion 55a corresponds to the inner portion of the second shaft portion main body 51c in the embodiment.

The second portions 55b extend in the radial direction from the first portion 55a to the outer peripheral surface of the shaft portion 51. In the embodiment, the second portions 55b are provided at a portion of the second shaft portion main body 51c on the upper side beyond the partitioning portion 54. The second portions 55b are opened to the inner portion of the first accommodation portion 91 in either of the opened state OS and the closed state CS. In the embodiment, a plurality of second portions 55b are provided. For example, a total of four second portions 55b are provided such that one second portion 55b is provided at a portion of a wall of the second shaft portion main body 51c on each of opposite sides in a first direction that perpendicularly intersects the axial direction and one second portion 55b is provided at a portion of a wall of the second shaft portion main body 51c on each of opposite sides in a second direction that perpendicularly intersects both the axial direction and the first direction.

The fluid W flows into the first portion 55a from the opening at the lower end of the second shaft portion main body 51c that is exposed to the first flow path portion 21 in the closed state CS by the connection flow path portion 55 being provided in this manner. Then, the fluid W that has flowed into the first portion 55a flows into the first accommodation portion 91 from the second portions 55b. In this manner, the state in which the fluid W is accommodated in the first accommodation portion 91 is achieved in the closed state CS. Note that since the first accommodation portion 91 is connected to the first flow path portion 21 via the connection flow path portion 55 even in the opened state OS as illustrated in FIG. 3, the fluid W flows into the first accommodation portion 91.

According to the embodiment, since the connection flow path portion 55 is provided at the inner portion of the shaft portion 51, it is possible to easily reduce the size of the movable portion 50 in the radial direction as compared to a case in which the connection flow path portion 55 is provided on the outer side in the radial direction beyond the shaft portion 51, for example. In addition, it is possible to easily create the first portion 55a by forming the second shaft portion main body 51c into a tubular shape. Therefore, it is possible to facilitate the production of the connection flow path portion 55.

In addition, according to the embodiment, the bottom portion 61 located at the portion between the valve body 52b and the partitioning portion 54 in the axial direction is provided, and the elastic member 80 is located between the partitioning portion 54 and the bottom portion 61. Therefore, it is possible to deliver the elastic force Fs of the elastic member 80 applied to the second shaft portion 51b to the first shaft portion 51a even if the first shaft portion 51a at which the core portion 53 is provided at the inner portion of the main body 40 and the second shaft portion 51b at which the partitioning portion 54 is provided at the outer portion of the main body 40 in the shaft portion 51 are provided as mutually separate members. In this manner, it is possible to cause the movable portion 50 to move to the upper side using the elastic member 80 when the shaft portion 51 is divided into the plurality of members and the state is switched from the closed state CS to the opened state OS. Therefore, it is possible to reduce the dimension of the second shaft portion main body 51c, at which the connection flow path portion 55 is provided, in the axial direction. Therefore, it is possible to easily produce the second shaft portion main body 51c in a tubular shape and to facilitate the production of the connection flow path portion 55.

### Second Embodiment

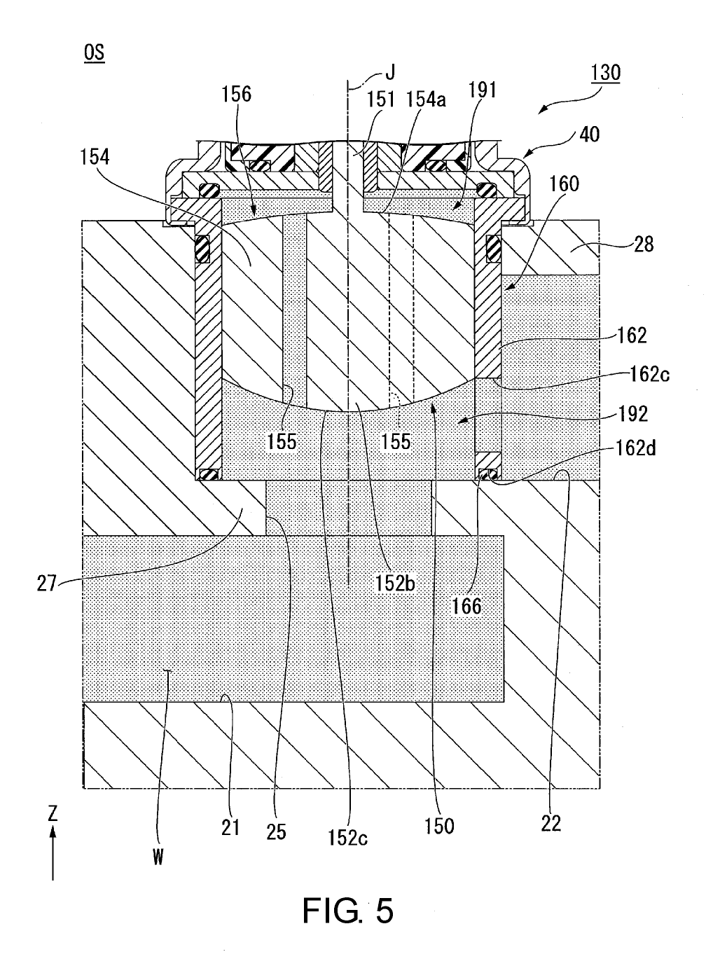

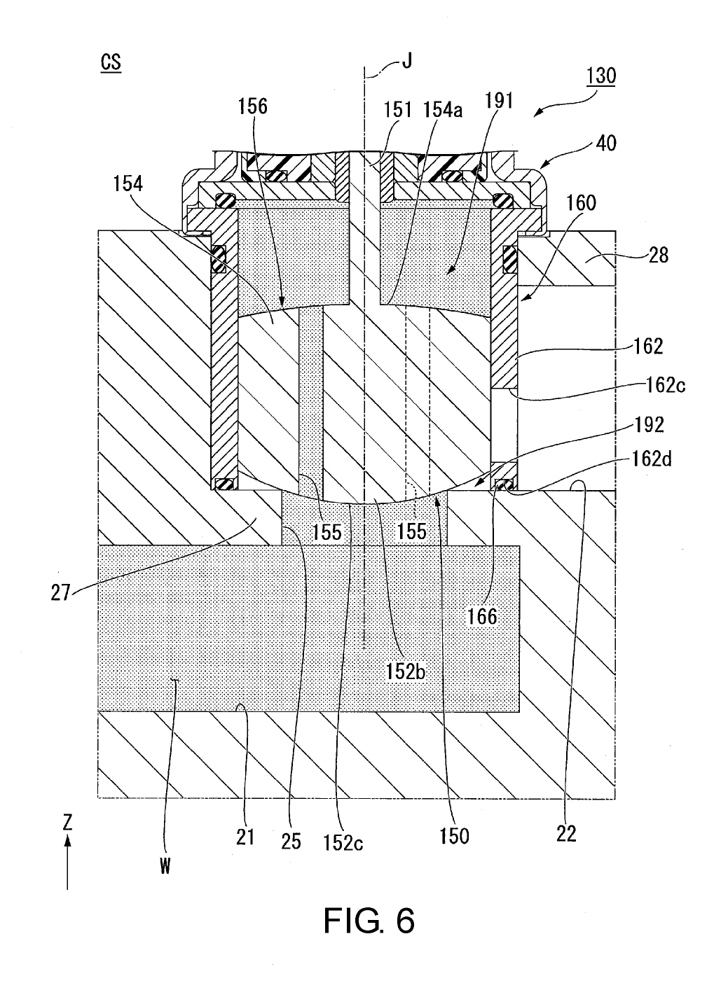

FIG. 5 illustrates an opened state OS of an electromagnetic valve 130 according to an embodiment. FIG. 6 illustrates a closed state CS of the electromagnetic valve 130 according to the embodiment. As illustrated in FIGS. 5 and 6, a tube member 160 in the electromagnetic valve 130 according to the embodiment does not have a bottom portion unlike the first embodiment. A tube member main body 162 of the tube member 160 is opened to the lower side and extends from a main body 40 to a partitioning wall 27. A lower end surface of the tube member main body 162 is brought into contact with an upper surface of the partitioning wall 27. That is, the lower end of the tube member 160 is opened to the lower side and is brought into contact with a surface in which a first hole 25 is provided in the embodiment. The tube member main body 162 surrounds the first hole 25 when seen in the axial direction.

The tube member main body 162 has a groove 162d that is recessed upwardly from the lower end surface of the tube member main body 162. The groove 162d has an annular shape in the circumferential direction. An O ring 166 is fitted into the groove 162d. The O ring 166 seals a portion between the lower end surface of the tube member main body 162 and the upper surface of the partitioning wall 27.

The tube member main body 162 has a second through-hole 162c that penetrates through the wall of the tube member main body 162 in the radial direction. That is, the tube member 160 has a second through-hole 162c that penetrates through the tube member 160 in the radial direction from the inner peripheral surface to the outer peripheral surface. The second through-hole 162c is provided at a lower portion of the tube member main body 162. As illustrated in FIG. 5, the second through-hole 162c connects the second accommodation portion 192 to the second flow path portion 22 in the opened state OS. In this manner, the fluid W flowing in the first flow path portion 21 flows into the second accommodation portion 192 from the first hole 25 and flows to the second flow path portion 22 via the second through-hole 162c in the opened state OS.

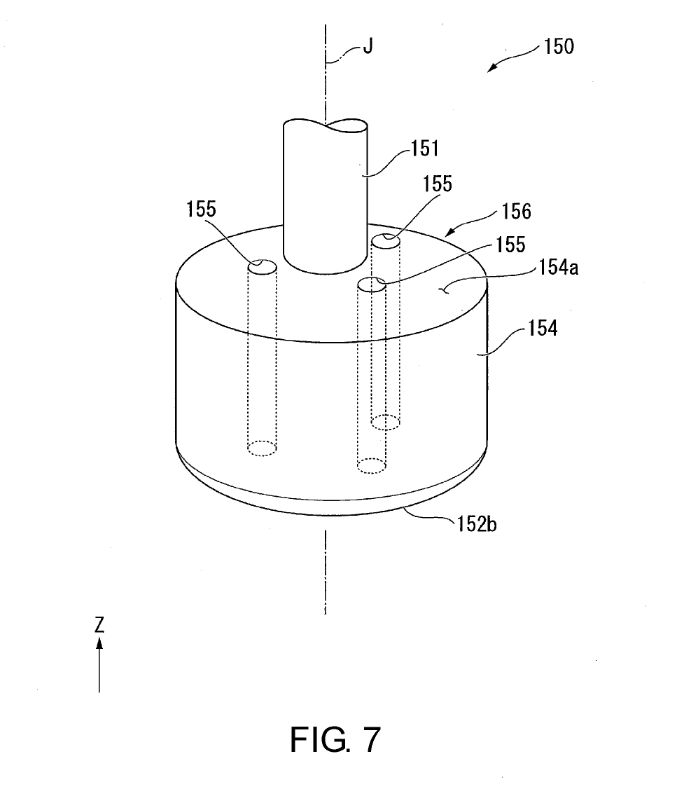

The shaft portion 151 has a circular columnar shape extending in the axial direction around the central axis J in the embodiment. The shaft portion 151 is a single member, for example, unlike the first embodiment. The movable portion 150 has an enlarged diameter portion 156 which an outer diameter is greater than that of the shaft portion 151 in the embodiment. The enlarged diameter portion 156 is connected to the lower end of the shaft portion 151. The enlarged diameter portion 156 is located at the inner portion of the tube member 160. As illustrated in FIG. 7, the enlarged diameter portion 156 has a cylindrical columnar shape around the central axis J in the embodiment. The outer peripheral surface of the enlarged diameter portion 156 is brought into contact with the inner peripheral surface of the tube member 160, that is, the inner peripheral surface of the tube member main body 162. When the movable portion 150 moves in the axial direction, the enlarged diameter portion 156 moves in the axial direction while the outer peripheral surface slides relative to the inner peripheral surface of the tube member main body 162.

In the embodiment, the enlarged diameter portion 156 serves as a partitioning portion 154. That is, the enlarged diameter portion 156 has a partitioning portion 154. The partitioning portion 154 partitions the inner portion of the tube member main body 162 into a first accommodation portion 191 and a second accommodation portion 192. In the embodiment, the second accommodation portion 192 is surrounded by the tube member 160, the partitioning portion 154, and the partitioning wall 27.

As illustrated in FIG. 6, the partitioning portion 154, that is, the enlarged diameter portion 156 blocks the second through-hole 162c with the outer peripheral surface in the closed state CS in the embodiment. A first pressure receiving surface 154a that is an upper surface of the partitioning portion 154 is a curved surface located on the lower side toward the outer side in the radial direction. In the embodiment, the lower end of the partitioning portion 154 is a valve body 152b. That is, the enlarged diameter portion 156 has a valve body 152b. The lower surface of the valve body 152b is a curved surface located on the upper side toward the outer side in the radial direction. The center of the lower surface of the valve body 152b serves as a second pressure receiving surface 152c. The area of the second pressure receiving surface 152c is smaller than the area of the first pressure receiving surface 154a in the embodiment.

In the embodiment, the connection flow path portions 155 are provided at the enlarged diameter portion 156 on the outer side in the radial direction beyond the shaft portion 151. Therefore, it is not necessary to form the shaft portion 151 into the tubular shape, and it is possible to easily produce the connection flow path portions 155 by performing working such as providing of holes in the enlarged diameter portion 156. In the embodiment, the connection flow path portions 155 are holes that penetrate through the enlarged diameter portion 156 in the axial direction and overlap the first hole 25 when seen in the axial direction. Therefore, the lower end of the connection flow path portions 155 is exposed to the first hole 25 in the closed state CS. In this manner, the fluid W flowing through the first flow path portion 21 flows into the first accommodation portion 191 from the first hole 25 via the connection flow path portions 155. Therefore, it is possible to reduce the output of the electromagnetic valve 130 necessary to maintain the closed state CS and to reduce the size of the electromagnetic valve 130 similarly to the first embodiment.

The upper ends of the connection flow path portions 155 are opened in the first pressure receiving surface 154a. The lower ends of the connection flow path portions 155 are opened in the second pressure receiving surface 152c. In the embodiment, the connection flow path portions 155 linearly extend in the axial direction. As illustrated in FIG. 7, the outer shapes of the connection flow path portions 155 when seen in the axial direction are circular shapes, for example.

A plurality of connection flow path portions 155 are provided at equal intervals in the circumferential direction. Therefore, it is easy to uniformly apply force that the enlarged diameter portion 156 receives from the fluid W flowing in and out from the first accommodation portion 191 via the connection flow path portions 155 in the circumferential direction when the enlarged diameter portion 156 moves in the axial direction. In this manner, it is possible to prevent the enlarged diameter portion 156 from being inclined and to smoothly move the enlarged diameter portion 156 in the axial direction. In the example illustrated in FIG. 7, three connection flow path portions 155 are provided, for example.

Although not illustrated in the drawing, an elastic member is provided at the inner portion of the main body 40 in the embodiment. The elastic member applies elastic force directed to the upper side to the shaft portion 151.

### Modification Example of Second Embodiment

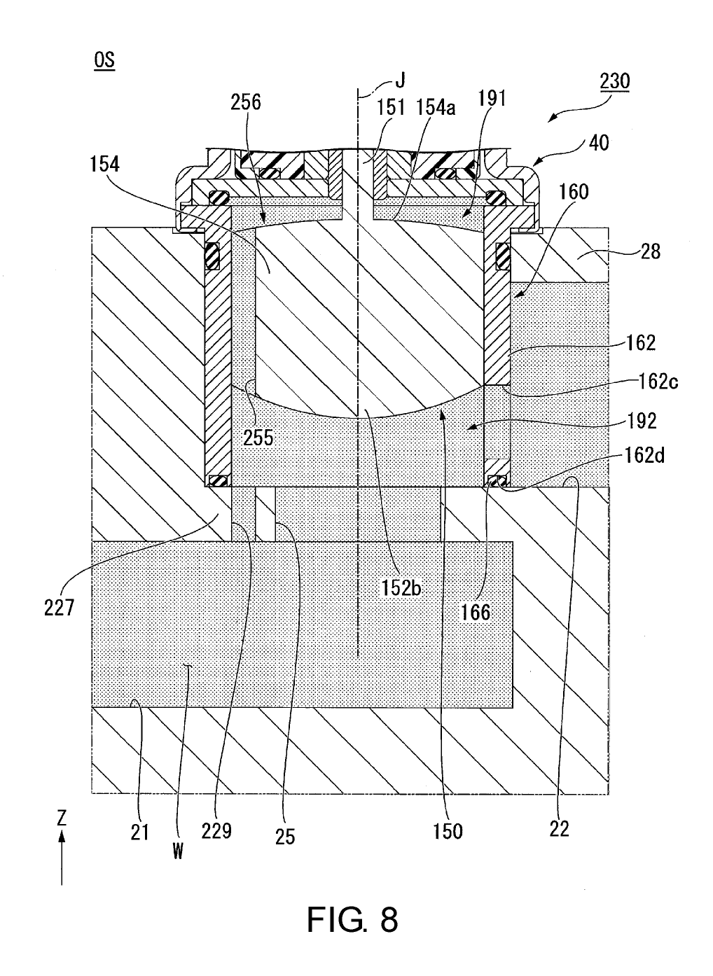

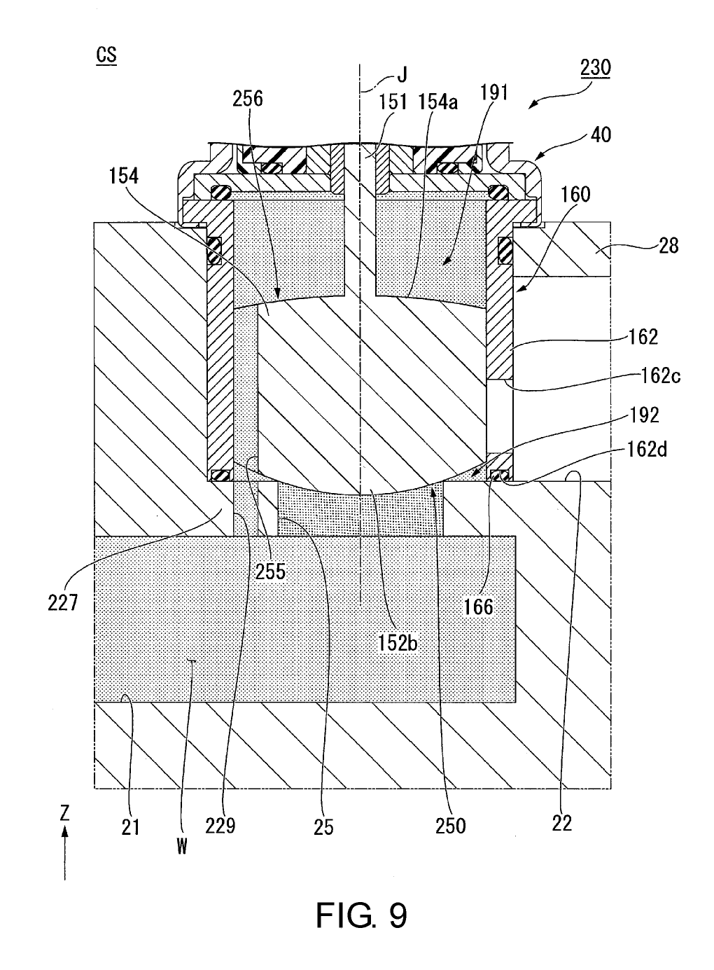

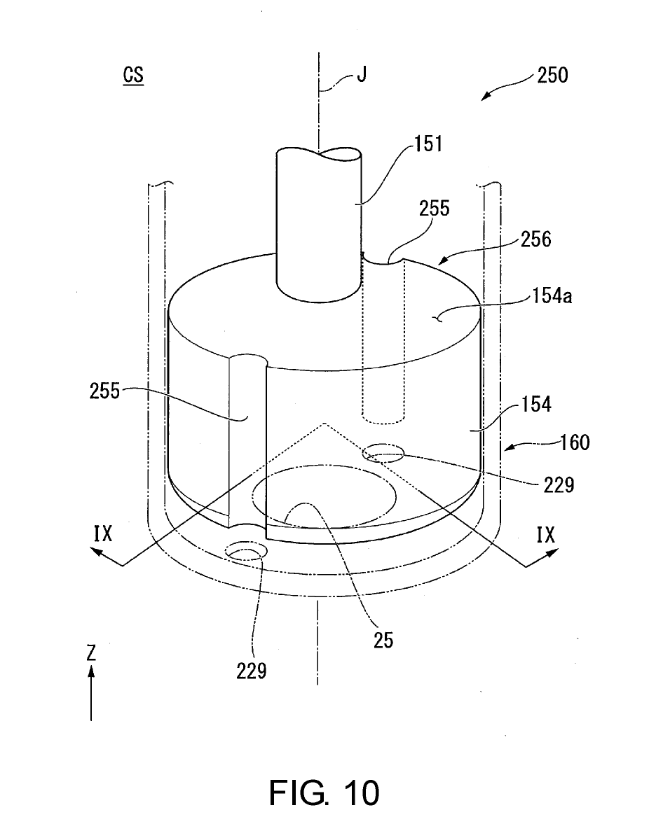

FIG. 8 illustrates an opened state OS of an electromagnetic valve 230 according to a modification example. FIGS. 9 and 10 illustrate a closed state CS of the electromagnetic valve 230 according to the modification example. Note that FIGS. 8 and 9 illustrate sectional views taken along IX-IX in FIG. 10 for explanation.

As illustrated in FIGS. 8 to 10, connection flow path portions 255 in the electromagnetic valve 230 according to the modification example are grooves recessed inwardly in the radial direction from an outer peripheral surface of the enlarged diameter portion 256 at a movable portion 250. The connection flow path portions 255 linearly extend from the lower end to the upper end of the enlarged diameter portion 256. The groove bottom surfaces of the connection flow path portions 255 have semi-arc shapes recessed inwardly in the radial direction when seen in the axial direction. The upper ends of the connection flow path portions 255 are opened in the first pressure receiving surface 154a. As illustrated in FIG. 10, a pair of connection flow path portions 255 are provided with the central axis J interposed therebetween in the radial direction, for example, in the modification example.

Openings of the connection flow path portions 255 on the outer side in the radial direction are blocked with the inner peripheral surface of the tube member 160. As illustrated in FIG. 9, the connection flow path portions 255 are connected to the first flow path portion 21 via the second holes 229 that are located on the outer side in the radial direction beyond the first hole 25 in the closed state CS.

The second holes 229 penetrate through the partitioning wall 227 in the axial direction. The second holes 229 are located at the inner portions of the tube member 160 when seen in the axial direction. Upper ends of the second holes 229 are opened to the inner portion of the tube member 160. Lower ends of the second holes 229 are opened to the first flow path portion 21. As illustrated in FIG. 10, the second holes 229 overlap the connection flow path portions 255 when seen in the axial direction according to the modification example. The second holes 229 are provided at locations at which the second holes 229 respectively overlap the respective connection flow path portions 255 in the axial direction. In the modification example, the second holes 229 are circular holes, for example.

As illustrated in FIG. 9, the fluid W flowing through the first flow path portion 21 flows into the first accommodation portion 191 from the second holes 229 via the connection flow path portions 255 in the closed state CS. Here, the fluid W flowing into the connection flow path portions 255 from the second holes 229 may also flows into a portion between the partitioning wall 227 and the enlarged diameter portion 256 in the axial direction, that is, into the second accommodation portion 192 in some cases. In the modification example, since the lower surface of the valve body 152b is a curved surface, the fluid W flows into the portion between the outer edge of the valve body 152b in the radial direction and the partitioning wall 227 in the axial direction.

However, the enlarged diameter portion 256 blocks the second through-hole 162c in the closed state CS even in the modification example. Therefore, it is possible to prevent the fluid W flowing into the second accommodation portion 192 from leaking from the second through-hole 162c to the second flow path portion 22 eve in a case in which the fluid W flows into the second accommodation portion 192. In this manner, it is possible to suitably disconnect the first accommodation portion 191 from the second flow path portion 22 in the closed state CS. As described above, it is possible to reduce the output of the electromagnetic valve 230 necessary to maintain the closed state CS with the fluid W accommodated in the first accommodation portion 191 and to reduce the size of the electromagnetic valve 230 even in the modification example.

Note that the connection flow path portions 255 and the second holes 229 may be disposed such that the positions thereof in the circumferential direction deviate from each other as long as the connection flow path portions 255 are connected to the second holes 229 in the closed state CS in the modification example. In this case, the fluid W flowing into the second accommodation portion 192 via the second holes 229 flows into the connection flow path portions 255 from the second accommodation portion 192.

The disclosure is not limited to the aforementioned embodiments, and other configurations described below can also be employed. The shape of the partitioning portion is not particularly limited as long as the partitioning portion can partition the inner portion of the tube member into the first accommodation portion and the second accommodation portion. Although the aforementioned second embodiment employs the configuration in which the enlarged diameter portion 156 serves as the partitioning portion 154 and the lower end of the partitioning portion 154 serves as the valve body 152b, the disclosure is not limited thereto. For example, the enlarged diameter portion may have a partitioning portion and a valve body that projects downwardly from the partitioning portion and has an outer diameter smaller than that of the partitioning portion. The area of the first pressure receiving surface may be different from the area of the second pressure receiving surface.

The connection flow path portions are not particularly limited as long as the connection flow path portions are provided at the movable portion and connect the first flow path portion to the first accommodation portion in the closed state CS. The connection flow path portions may extend in a curved manner. The number of the connection flow path portions is not particularly limited. The connection flow path portions may not connect the first flow path portion to the first accommodation portion in the opened state OS.

Note that purposes of the electromagnetic valve and the flow path device according to the aforementioned embodiments are not particularly limited. Also, the aforementioned respective configurations may appropriately be combined without conflicting with each other.

What is claimed is:

1. An electromagnetic valve that includes a movable portion that is movable along a central axis extending in an axial direction and that switches a state between an opened state in which a first flow path portion and a second flow path portion located on one side of the first flow path portion in the axial direction are connected to each other via a first hole and a closed state in which the first hole is blocked and the first flow path portion and the second flow path portion are disconnected, the electromagnetic valve comprising:
a main body that has a solenoid that causes the movable portion to move in the axial direction and a cover that accommodates the solenoid;
a tube member with a tubular shape that extends from the main body to the other side in the axial direction; and
a connection flow path portion that connects an outer portion of the electromagnetic valve to an inner portion of the tube member,
wherein the movable portion has
a shaft portion that projects on the other side in the axial direction from the main body and is inserted into the inner portion of the tube member,
a valve body that is provided at the shaft portion and blocks the first hole from the one side in the axial direction in the closed state, and
a partitioning portion that widens outwardly in a radial direction from an outer peripheral surface of a portion of the shaft portion that is inserted to the inner portion of the tube member,
the partitioning portion is located on the one side in the axial direction beyond the valve body and partitions the inner portion of the tube member into a first accommodation portion and a second accommodation portion that is located on the other side of the first accommodation portion in the axial direction,
the second flow path portion is connected to the second accommodation portion in the opened state,
the connection flow path portion is provided at the movable portion and connects the first flow path portion to the first accommodation portion in the closed state, and
the first accommodation portion accommodates a fluid flowing through the first flow path portion and is disconnected from the second flow path portion in the closed state.

2. The electromagnetic valve according to claim 1, further comprising:
an elastic member that applies elastic force directed to the one side in the axial direction to the movable portion,
wherein the connection flow path portion has
a first portion that is provided inside the shaft portion and extends in the axial direction, and
a second portion that extends in the radial direction from the first portion to an outer peripheral surface of the shaft portion,
the tube member has
a tube member main body with a tubular shape that extends from the main body to the other side in the axial direction, and
a bottom portion that is connected to an end of the tube member main body on the other side in the axial direction and is located between the valve body and the partitioning portion in the axial direction,
the bottom portion has a first through-hole through which the shaft portion is caused to pass,
an end of the elastic member on the one side in the axial direction is in contact with the partitioning portion, and
an end of the elastic member on the other side in the axial direction is in contact with the bottom portion.

3. The electromagnetic valve according to claim 2, further comprising:
a sealing member that is disposed on a surface of the bottom portion on the one side in the axial direction on an outer side in the radial direction beyond the first through-hole,
wherein the sealing member has an annular shape surrounding the shaft portion and seals a portion between a surface of the bottom portion on the one side in the axial direction and a surface of the partitioning portion on the other side in the axial direction in the closed state.

4. The electromagnetic valve according to claim 1, wherein
an end of the tube member on the other side in the axial direction is opened on the other side in the axial direction and is in contact with a surface in which the first hole is provided,
the tube member has a second through-hole that penetrates through the tube member in the radial direction from an inner peripheral surface to an outer peripheral surface,
the second through-hole connects the second accommodation portion to the second flow path portion in the opened state,
the movable portion has an enlarged diameter portion with an outer diameter that is larger than the shaft portion,
the enlarged diameter portion has the partitioning portion and the valve body, and
the connection flow path portion is provided at the enlarged diameter portion on an outer side in the radial direction beyond the shaft portion.

5. The electromagnetic valve according to claim 4, wherein the connection flow path portion is a hole that penetrates through the enlarged diameter portion in the axial direction and overlaps the first hole when seen in the axial direction.

6. The electromagnetic valve according to claim 4, wherein
the connection flow path portion is a groove that is recessed on the inner side in the radial direction from an outer peripheral surface of the enlarged diameter portion and is connected to the first flow path portion via a second hole that is located on the outer side in the radial direction beyond the first hole in the closed state,
an opening of the connection flow path portion on the outer side in the radial direction is blocked with the inner peripheral surface of the tube member, and
the enlarged diameter portion blocks the second through-hole in the closed state.

7. The electromagnetic valve according to claim 4, wherein a plurality of connection flow path portions are provided at equal intervals in a circumferential direction.

8. The electromagnetic valve according to claim 5, wherein a plurality of connection flow path portions are provided at equal intervals in a circumferential direction.

9. The electromagnetic valve according to claim 6, wherein a plurality of connection flow path portions are provided at equal intervals in a circumferential direction.

10. A flow path device comprising:
the electromagnetic valve according to claim 1; and
a flow path portion that has the first flow path portion, the second flow path portion, and the first hole.
